(19) United States
(12) Patent Application Publication
(10) Pub. No.: US 2020/0361425 A1
(43) Pub. Date: Nov. 19, 2020

(54) APPARATUS FOR CLEANING OBJECTS, IN PARTICULAR TWO-WHEEL VEHICLES

(71) Applicant: Sachin Kumar, Koeln (DE)

(72) Inventor: Sachin Kumar, Koeln (DE)

(21) Appl. No.: 15/779,471

(22) PCT Filed: Oct. 26, 2016
(86) PCT No.: PCT/EP2016/075785

§ 371 Date: May 25, 2018

(30) Foreign Application Priority Data
Oct. 28, 2015 (DE) 10 2015 118 371.4
Apr. 16, 2016 (DE) 20 2016 102 020.4
Jun. 22, 2016 (DE) 10 2016 111 486.3

(51) Int. Cl. B60S 3/04

(52) U.S. Cl. CPC B60S 3/041; B60S 3/063

(57) ABSTRACT

An apparatus for cleaning an object, such as a two-wheeled vehicle, includes a housing that accommodates a cleaning device and has an open side on which the object and the housing can be positioned relative to one another and from which the cleaning device can be operated so as to act on the object. The cleaning device is provided with a control device for controlling the cleaning device. The apparatus allows objects, such as two-wheeled vehicles, to be cleaned in a simple manner while keeping costs, the amount of material used and energy consumption low.

The present invention relates to an apparatus according to the preamble of the independent claim.

With an increased number of particularly high-quality two-wheel vehicles, the desire for a well-maintained condition is increasing. Similarly, bicycle rental companies with a large fleet and its use in extreme terrains are very interested in cleaning. Recreational cyclists attach growing importance to a well-maintained appearance of their two-wheel vehicles.

Document DE 43 25 973 C1 discloses an apparatus for cleaning a two-wheel vehicle, in particular a bicycle, with a cabin enclosing the two-wheel vehicle at least laterally and above in which a cleaning device containing a spraying and/or drying device is arranged, wherein the cleaning device comprises at least two rotatable brush-like cleaning rollers positioned on both sides of the two-wheel vehicle with spraying and/or drying devices associated with the cleaning rollers, which can be moved together laterally along the two-wheel vehicle by means of a movable carriage on a longitudinal rail running parallel to the longitudinal axis of the two-wheel vehicle.

Such a device is very expensive due to the high material costs. For example, the cleaning rollers are very large and can only be guided horizontally along the bicycle. Accordingly, the consumption of water, cleaning agents and preservatives is also high.

The problem underlying the invention is to provide an apparatus and a method for cleaning objects, in particular two-wheel vehicles, in particular bicycles, in such a way that a two-wheel vehicle is cleaned in a simple, cost-effective and effective manner. Thereby, a multitude of two-wheel vehicles is intended to be cleaned in succession. An apparatus is especially supposed to be producible in a material-saving manner, have a low mass, be easy to transport and have a long service life. The use of the device should be simple and reliable. In particular, a consumption of energy and cleaning media should be small in relation to a cleaning effect. Dirt and a cleaning medium are to be kept inside the apparatus. The cleaning effect is to be increased and a loss of cleaning medium reduced.

The problem is solved by an apparatus with the features according to the independent claim.

According to one aspect, an apparatus for cleaning an object, in particular a two-wheel vehicle, is proposed, wherein a housing accommodating a cleaning device is provided with an open side on which the object and the housing can be positioned relative to one another and from which the cleaning device can be operated so as to act on the object, wherein the cleaning device has a control device for controlling the cleaning device.

A two wheel-vehicle extends in particular with the two wheels and a frame along a longitudinal direction. A two-wheel vehicle longitudinal axis is in particular an axis of symmetry of the two-wheel vehicle and runs along the two wheels and the frame when the handlebars of the two-wheel vehicle are straight ahead.

According to another aspect, it is proposed to use two inventive apparatuses, wherein the two apparatuses are positioned side by side along a longitudinal direction, the open side of the first apparatus facing the open side of the second apparatus. In this arrangement, the two-wheel vehicle can be cleaned from both sides in one pass without turning, whereby time and costs can be saved.

This reduces the material used to manufacture the apparatus and its complexity compared to the state of the art. During operation, little water, cleaning agents and preservatives are required. At dirty areas, the two-wheel vehicle can be cleaned, dried and preserved. Energy consumption for moving the cleaning device is effectively reduced.

Further advantageous configurations are claimed in connection with the dependent claims.

According to an advantageous configuration, the cleaning device may comprise two brush-like cleaning rollers which can be rotated by means of (an) electric motor(s). The electric motors can be arranged inside the cleaning rollers.

According to a further advantageous configuration, the cleaning rollers can be connected to a drum motor by means of grub screws. In particular, the cleaning rollers can be mounted via a plastic bearing, wherein water channels for the waste water can be provided in the plastic bearing so that no water can enter the bearing and, thus, lubrication of the bearing with lubricating grease and/or lubricating oil can be avoided. According to a further advantageous configuration, the cleaning rollers can be mounted rotatably on the housing. In particular, the cleaning rollers are fixed in such a rigid manner that no movement of the cleaning rollers takes place in the vertical direction or in the longitudinal direction of the device. Maintenance and repair costs can be minimized due to the reduction of movable parts.

The cleaning rollers can be sprayed with cleaning medium from the side facing away from the object. This avoids direct spraying of the object, if necessary under high pressure so that the risk of possible damage is reduced.

According to a further advantageous configuration, the cleaning device can have a rotatable nozzle cleaning head for dispensing cleaning medium in an intermediate area between the two rotatable cleaning rollers on the open side. Thereby, the rotating nozzle cleaning head can spray the object to be cleaned with cleaning medium from below. In addition to this, further horizontally aligned nozzle cleaning heads can be provided with which particularly dirty areas of the object can be cleaned. An operator can position the object to be cleaned, especially with the particularly dirty areas in the region of the nozzles.

According to a further advantageous configuration, the area of the housing accommodating the cleaning device may comprise blinds or brushes along the edge of its open side in the direction of the object for collecting cleaning medium.

According to a further advantageous configuration, the control device may be arranged so as to rotate the cleaning rollers in opposite directions of circulation in a first operating mode, wherein in particular a first of the cleaning rollers rotates counter-clockwise seen from above and a second of the cleaning rollers rotates clockwise seen from above.

According to a further advantageous configuration, the control device can be adapted so as to rotate the cleaning rollers in a second operating mode alternately for a period of seconds in the clockwise and counter-clockwise direction, respectively.

According to a further advantageous configuration, the control device can be adapted so as to switch from the first operating mode to the second operating mode when the object to be cleaned is pressed against the cleaning rollers, and in this way, the electromotive power requirement increases.

According to a further advantageous configuration, the control device can be adapted so as to switch from the second operating mode to the first operating mode when the object to be cleaned is removed from the cleaning rollers, and in this way the electromotive power requirement decreases.

According to a further advantageous configuration, the control device can be adapted so as to switch off the cleaning rollers and/or the apparatus in such a way that they can be switched on again, if a limit value for a pressure against the cleaning rollers is exceeded.

According to a further advantageous configuration, a circuit comprising a container and filter can be configured within the device which circulates the cleaning medium, in particular water. A circuit has the advantage that no water connection is required for the apparatus. The cleaning medium is filtered after each washing cycle and can be reused for the next cleaning.

According to a further practical embodiment, a filter area spaced apart from the object to be cleaned can be integrated into the circuit. The contaminated cleaning medium enters the filter area via a grid-like structure. The filter area comprises a filter mat and loose filter material, such as filter balls, is arranged above it. As an alternative to a filter mat, two filter mats with different degrees of fineness can also be used.

The filter material, such as the filter balls, can preferably be arranged in a net. This has the advantage that the filter material can be easily exchanged and the filter material also cannot easily get into the subsequent pumping system.

The cleaning medium is pumped through the filter and the loose bulk into a filter cartridge by a pump and then pumped into the nozzle cleaning heads. From there, the filtered cleaning medium returns to the object to be cleaned. Such a filter area with a filter mat and loose filter material can be easily and cost-effectively maintained and/or replaced.

The filter mat and the loose bulk can be partially separated in a labyrinth-like manner by Z-partitions so that the cleaning medium initially flows through the filter element and then through the loose bulk when viewed in the direction of flow.

Inside the container for the cleaning medium, a tank for fresh water may be additionally arranged for subsequent rinsing of the object. Thereby, installation space and material can be saved.

In addition, a dosing pump may be arranged on the device by means of which an optimum dose of cleaning agent can be determined and adjusted.

An apparatus according to the invention may in particular comprise several elements which can be assembled modularly, in particular detachably connected. Preferably, the apparatus includes separately mountable cleaning rollers, a container as main tank, a tank for water for pre-washing and a splash guard. Such a modularly assembled apparatus can be easily adapted and equipped with further elements as required. Moreover, the apparatus is easy to assemble and dismantle for transport.

The object to be cleaned may either be moved through the apparatus by an operator which means that no additional support structure and, in particular, no conveying device for the object needs to be arranged. Alternatively, the device may be designed such that the object is moved through the device by the force exerted on the object by the cleaning rollers.

With regard to the embodiment in which two apparatuses are arranged opposite each other, it is referred to the possibility of securing, holding and, if necessary, moving the object to be cleaned through the apparatus by means of ropes.

In a further advantageous configuration of the apparatus, a pre-washing area is provided spaced apart from the open side, wherein high-pressure nozzles are arranged in the pre-washing area to generate a jet with cleaning medium with which a heavily soiled object can first be cleaned and/or the dirt soaked. Preferably, the high-pressure nozzles generate a jet of at least 9 bar. The pressure can be achieved by means of an air compressor or a positive displacement pump.

In a particular environmentally friendly embodiment, a prewashing area as described above, has a pre-washing tank which is connected to the main tank in a flow-conducting manner. The collected wastewater from the prewashing area is recycled in the same cycle as the cleaning agent from the apparatus.

In a further advantageous configuration, a guide trough is formed in the accommodation area. The guide trough can be formed in particular by rollers. A total of 20 to 25 rollers are provided for this purpose. The rollers can be mounted on a plastic ball bearing. When a bicycle is passed through, the cleaning brushes exert a force on the spokes and wheels of the bicycle such that they rotate on the rollers and the bicycle moves through the apparatus. The rollers are preferably made of plastic, especially PVC.

In a further advantageous configuration of the apparatus, a blind or a brush, preferably a strip brush, is arranged in the inlet and/or the outlet into the guide trough for the object to be cleaned. The brush can be coated with plastic, such as PVC, on the side facing the guide trough to make it easier to prevent cleaning media from escaping from the apparatus.

In a further advantageous configuration of the apparatus, the energy consumption of the apparatus is less than 250 W. Preferably, the energy requirement can be generated by means of a solar panel arranged on the apparatus.

In particular, the apparatus can have an Internet connection that allows a customer to pay and start the cleaning process immediately afterwards. Thereby, a device can be used autonomously without additional operator. In addition, the current status of the device can be transmitted to the provider via the Internet.

The invention is described in more detail below by means of embodiments in connection with the Figures. These following explanations are not intended to limit the scope of protection but rather to explain the invention. Therein:

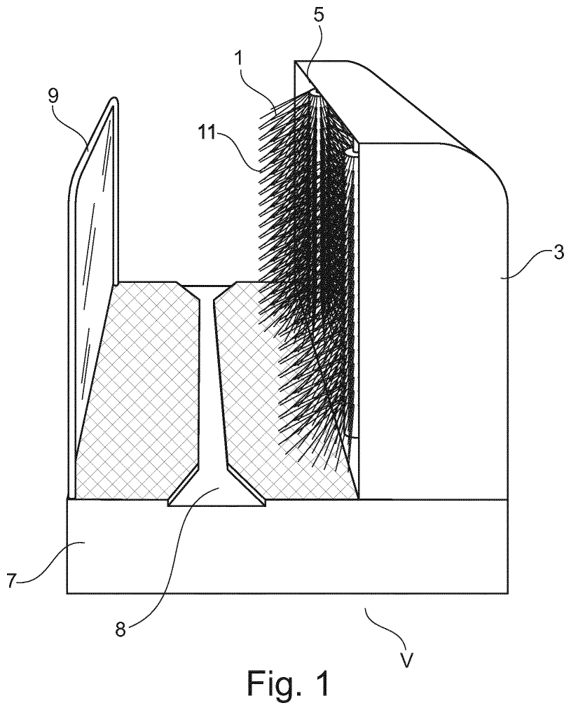

FIG. 1 shows a side view of an embodiment of an apparatus according to the invention;

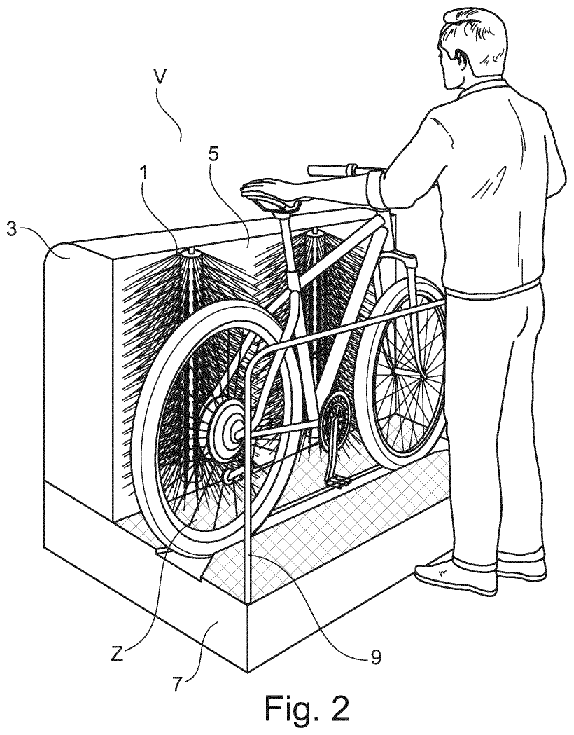

FIG. 2 a side view of an embodiment in operation;

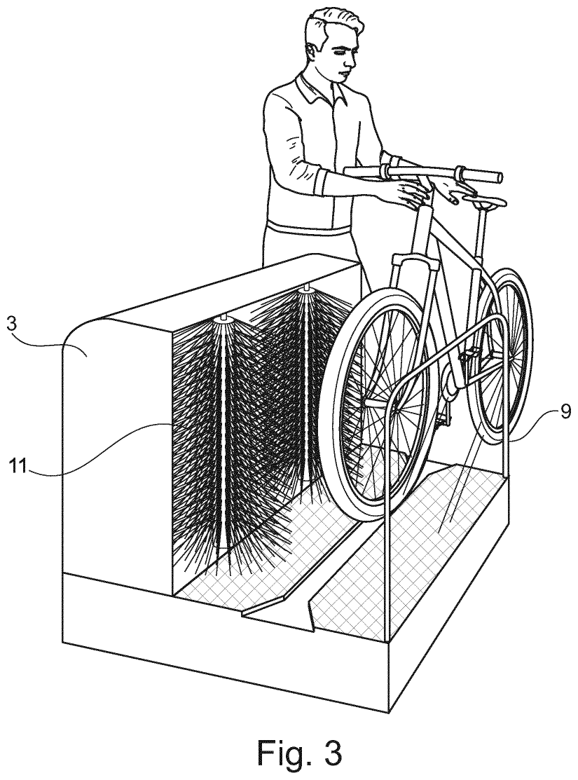

FIG. 3 a further side view of the embodiment in operation;

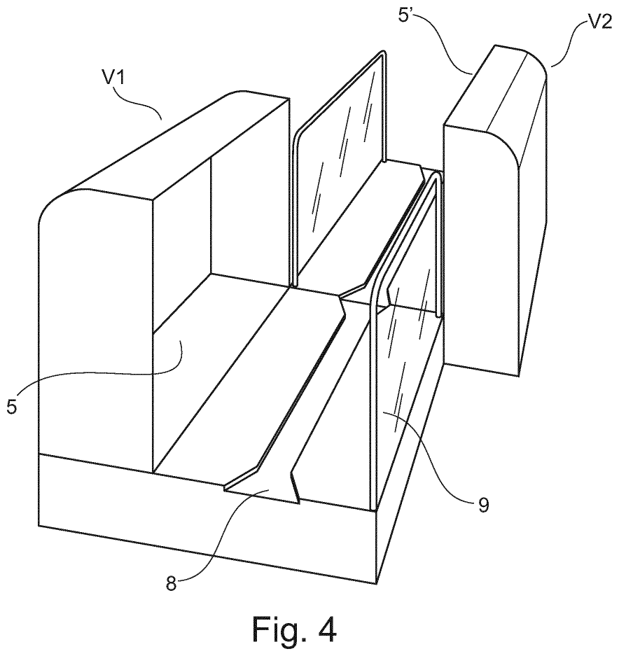

FIG. 4 an embodiment of two apparatuses according to the invention;

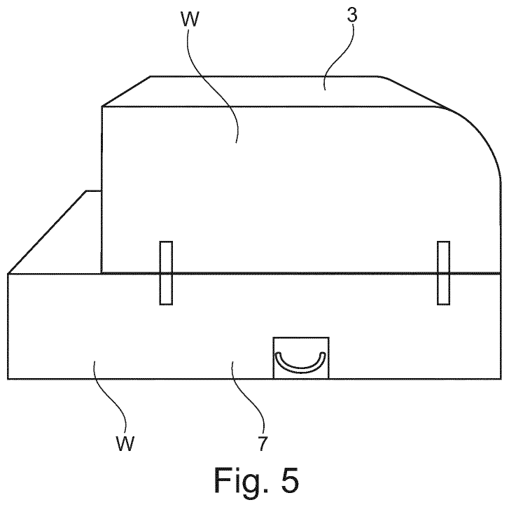

FIG. 5 a further side view of an embodiment of an apparatus according to the invention;

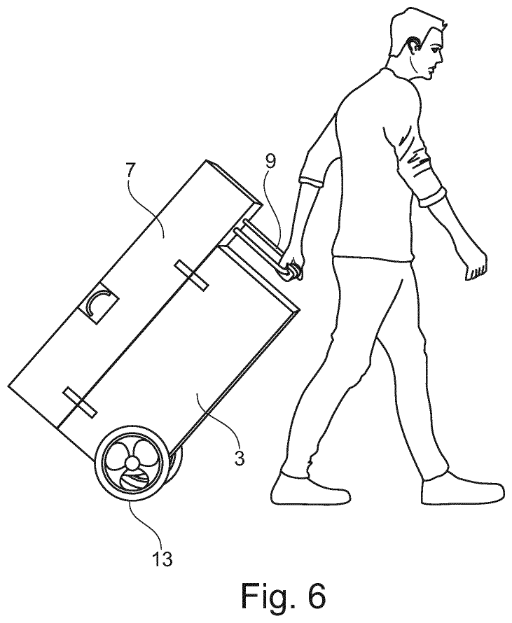

FIG. 6 a further view of the embodiment of an apparatus according to the invention during transport;

FIG. 7 a further view of the embodiment of an apparatus according to the invention during transport;

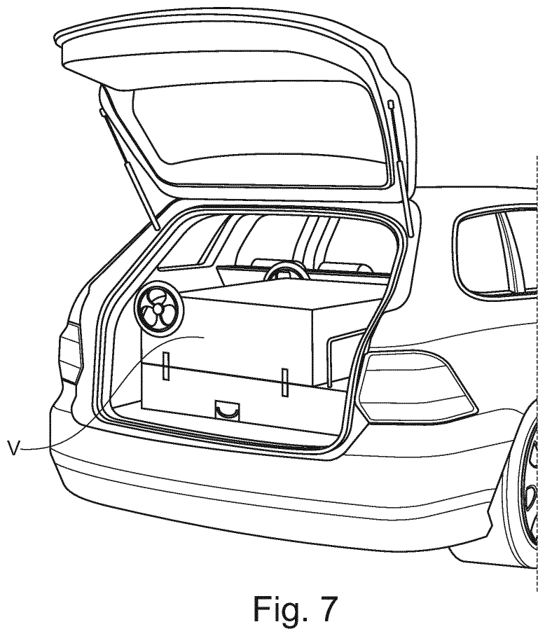

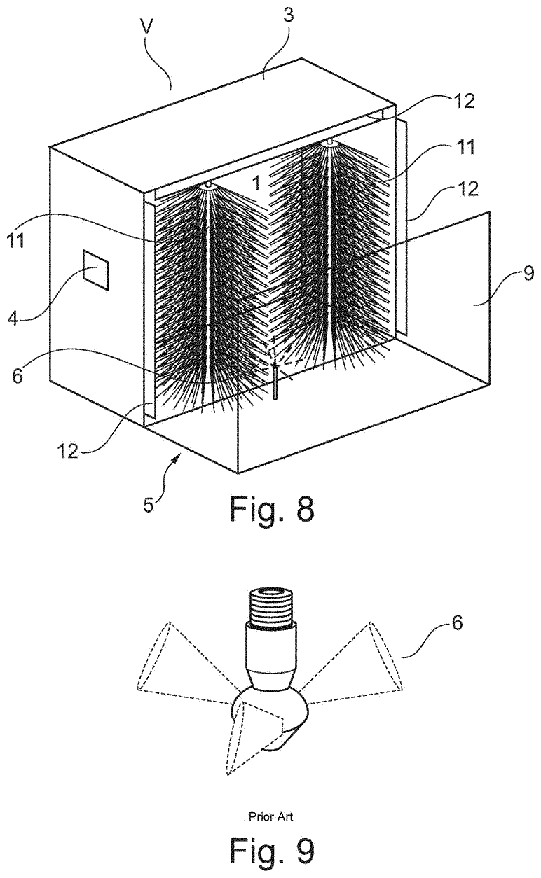

FIG. 8 a further view of the embodiment of the apparatus according to the invention;

FIG. 9 a view of a cleaning head;

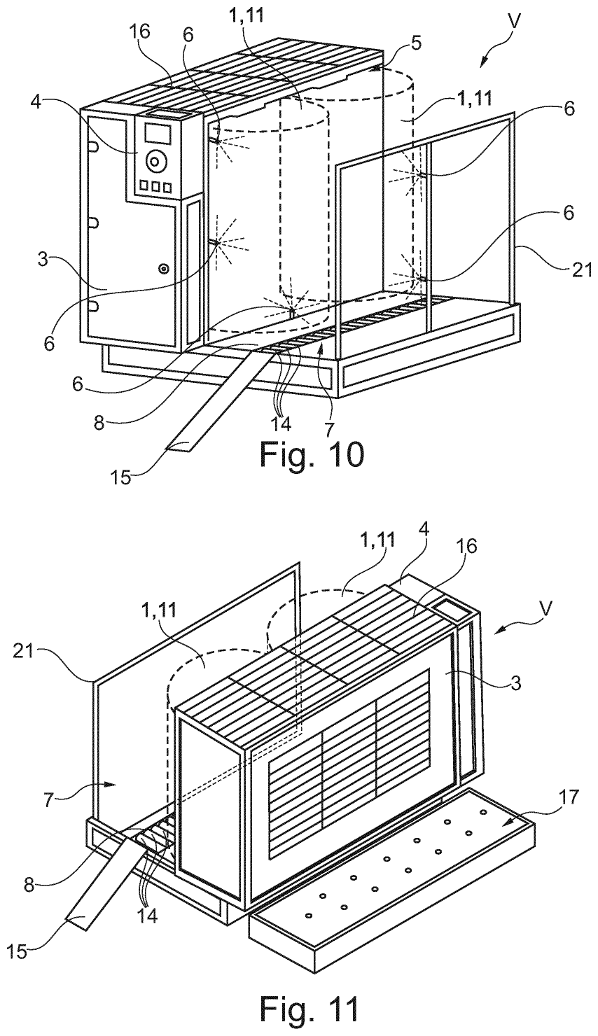

FIG. 10 a second embodiment of an apparatus according to the invention in a perspective view from an oblique front;

FIG. 11 the apparatus from FIG. 10 in a perspective view from an oblique rear;

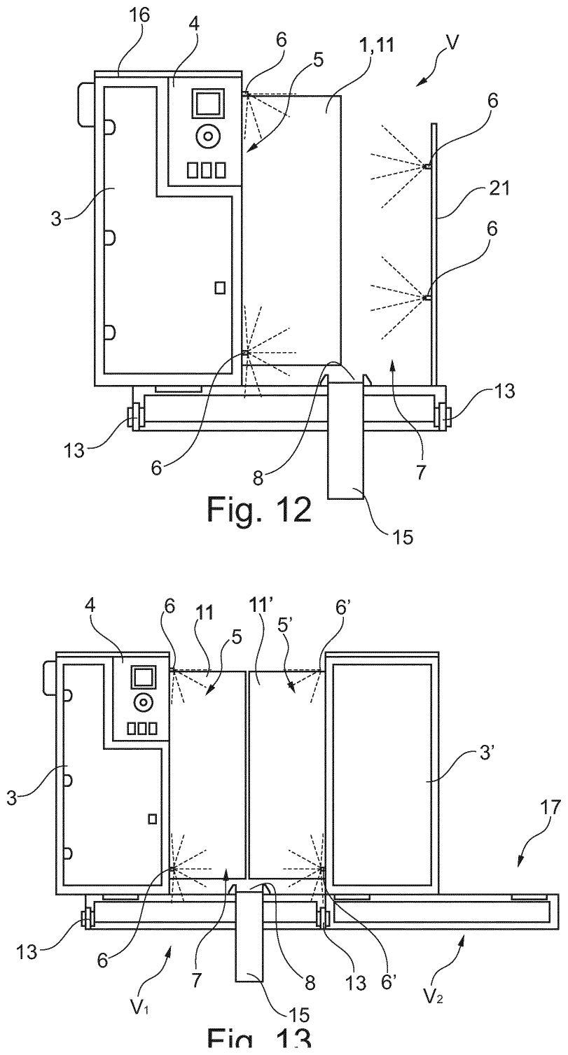

FIG. 12 the apparatus from FIG. 10 in a front view;

FIG. 13 a third embodiment of an apparatus according to the invention in a front view;

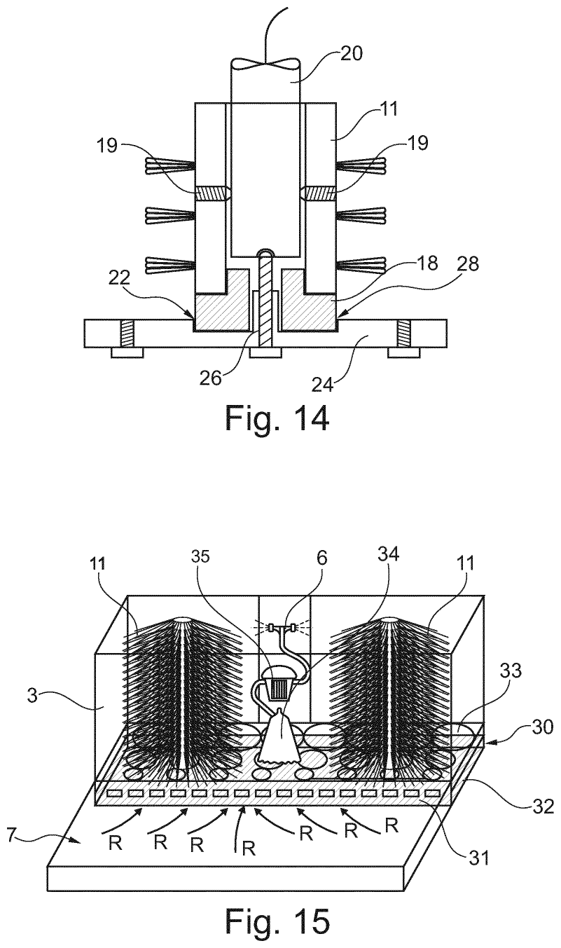

FIG. 14 a bearing for a cleaning roller in a side view

FIG. 15 a fourth embodiment of an apparatus according to the invention in a perspective side view,

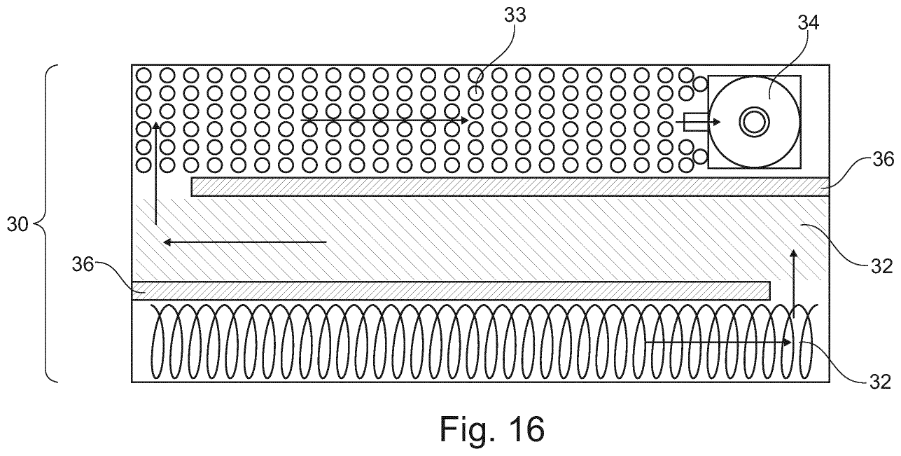

FIG. 16 a filter area from FIG. 15 in a side view,

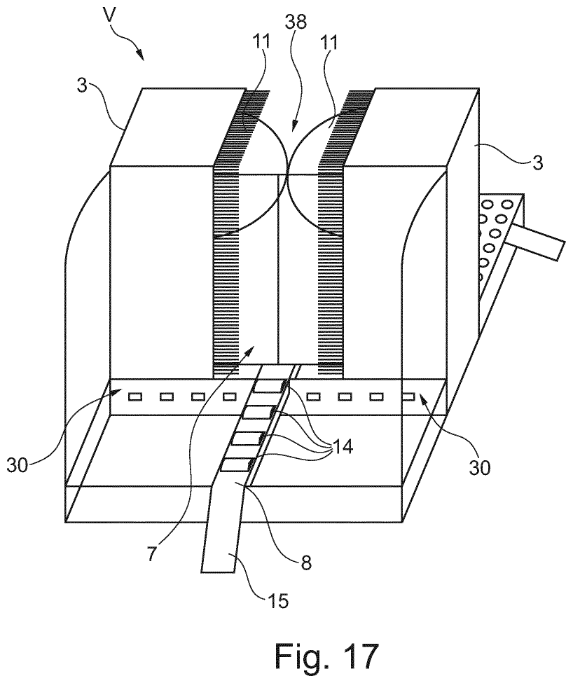

FIG. 17 a fifth embodiment in a perspective front view.

FIG. 1 shows a side view of an embodiment of an apparatus V according to the invention. The apparatus V comprises a cleaning device 1 which is positioned and in particular fixed in a housing 3. For example, a number, in particular two cleaning rollers 11, can be rotatably mounted vertically in the housing 3. For example, the cleaning rollers 11 can be moved by means of electric motors arranged along the axes of rotation within the cleaning rollers 11. The two cleaning rollers 11 can be rotated in any direction of rotation. The housing 3 comprises at least one open side 5. The housing 3 can additionally comprise a bottom, a cover, two front faces and a further side cover opposite the open side 5. In this way, the cleaning device 1 with the cleaning rollers can be fixed in the housing 3, largely protected from external mechanical forces. From the open side 5 an access to the cleaning rollers 11 can be formed. During the cleaning of an object, in particular a two-wheel vehicle Z, the housing 3 also acts as protection so that no cleaning agent is released from the cleaning device 1 into the environment, for example, to a person. The bottom of the housing 3 according to this embodiment is guided out at the open side 5 from below the cleaning device 1 and thereby creates an accommodation area 7 for carrying and positioning the object to be cleaned, in particular the two-wheel vehicle Z. The receiving area 7 forms a guide trough 8 along which a two-wheel vehicle Z to be cleaned, which is shown in FIGS. 2 and 3, can be moved by a person. In this way, a certain distance between a two-wheel vehicle Z and the cleaning rollers 11 is adjustable. The two-wheel vehicle Z and the housing 3 can be arranged in relation to each other and the cleaning device 1 can act on the two-wheel vehicle Z by means of the cleaning rollers 11 through the open side 5 and, for example, brush it and/or apply a cleaning fluid to it. The cleaning device 1 may comprise a spraying device and/or a drying device. Opposite to the open side 5, a holding device 9 is attached to the end region of the bottom there in the form of a holding bracket to which a person can hold on, but to which also a two-wheel vehicle Z can be leaned. On the side facing a two-wheel vehicle Z, the accommodation area 7 can comprise a coating with a non-slip surface profile so that this can offer a hold for a walking person. The coating can also repel a cleaning liquid and protect the apparatus from wear.

FIG. 2 shows a side view of the embodiment of the apparatus V according to FIG. 1 in operation. It is shown how an operator moves a two-wheel vehicle Z along the guide trough 8 into a relative and cleaning position to the cleaning rollers 11 of the cleaning device 1 fixed in the housing 3. From the open side 5, the cleaning rollers 11 initially brush a first side of the two-wheel vehicle Z which is placed on the accommodation area 7. Between the two-wheel vehicle Z and the operator, a holding bracket is fixed which also distances the operator from the bicycle and protects it. The operator may hold the two-wheel vehicle Z during cleaning and may also press the two-wheel vehicle Z against the cleaning rollers with a selected force to improve the cleaning effect.

FIG. 3 shows a further side view of the embodiment of the apparatus V according to FIG. 1 in operation. In contrast to FIG. 2, the second side of the two-wheel vehicle Z is now cleaned. FIG. 3, as an alternative to FIG. 2, shows that the operator can assume a further relative position to the two-wheel vehicle Z and the apparatus V during cleaning. Reference numeral 9 designates a bracket which additionally protects against the two-wheel vehicle Z to be cleaned.

FIG. 4 shows an embodiment of the use of two apparatuses V1 and V2 according to the invention. Thereby, apparatuses V1 and V2 according to the invention are modularly strung together. The apparatuses V1 and V2 are identical in construction. The apparatuses V1 and V2 are arranged to one another in the longitudinal direction along their guide troughs 8 and 8′. The open side 5 of the first apparatus V1 faces the open side 5′ of the second apparatus V2. In this way, a two-wheel vehicle Z that is moved along the two guide troughs 8 and 8′ can be cleaned initially on one side and subsequently on the second side, without the two-wheel vehicle Z having to be turned over and guided along a single apparatus V again. Cleaning rollers 11 can be rotatably mounted horizontally, vertically and/or diagonally in a housing 3.

FIG. 5 shows a further side view of the embodiment of an apparatus according to the invention according to FIG. 1 now in a collapsed state. The accommodation area 7 of the bottom and the area of the housing 3 accommodating the cleaning device 1 are laid on top of each other such that the open side 5 is covered. For example, the accommodation area 7 can be mechanically connected to the area of the housing 3 accommodating the cleaning device 1 by means of a swivel joint. The housing 3 can be folded into the accommodation area 7 and covered. In this position, the apparatus can be releasably locked by means of mechanical locks. The accommodation area 7 of the bottom and the area of the housing 3 accommodating the cleaning device 1 can be designed in the form of a tub W or a bowl or a box. This enables the apparatus to be handled corresponding to a suitcase. A handle may be arranged on the apparatus V.

FIG. 6 shows a further view of the embodiment of an apparatus according to the invention during transport. When collapsed, a person can grasp and pull the apparatus V by the bent rod and/or the bracket 9, wherein the apparatus can be moved by means of transport rollers 13. The housing 3 comprises at least one transport roller 13 or at least one wheel on its bottom on the side facing away from the open side 5.

FIG. 7 shows a further view of the embodiment of an apparatus V according to the invention during transport. The apparatus V can be easily accommodated and transported in the boot of a motor vehicle or passenger car.

The dimensions of the apparatus V according to the invention in the collapsed state are 1.44 m×0.85 m×0.55 m (W×H×D).

When unfolded, the dimensions of the apparatus V are presently 1.44 m×0.85 m×0.95 m.

The weight of the apparatus V is here approx. 80 kg.

FIG. 8 shows a further view of the embodiment of an apparatus according to the invention. The apparatus V for cleaning an object, in particular a two-wheel vehicle Z, comprises a housing 3 accommodating a cleaning device 1 with an open side 5 on which the object and the housing 3 can be positioned relative to one another and from which the cleaning device 1 can be provided acting on the object. In addition, a control device 4 for controlling the cleaning device 1 is assigned to the cleaning device 1.

The cleaning device 1 comprises a rotatable nozzle cleaning head 6 for dispensing cleaning medium in an intermediate area between the two rotatable cleaning rollers 11 on the open side 5. The cleaning head 6 is arranged in a lower spatial area such that the bicycle pedals are not touched. The cleaning head 6 can also be easily repositioned after an adjustment. For example, the cleaning head 6 sprays the water into the air in the direction of an upper hemisphere when rotating around a vertical axis. Due to the position between the cleaning brushes or cleaning rollers 11, this spatial area of the hemisphere is reduced to the front towards the object. Spray jets can extend from 0° to 90° to the vertical to the object when rotating around a vertical axis. Otherwise, the spray jets are absorbed by the cleaning rollers 11. The supply with the cleaning medium, here water, can be effected by means of a pipeline. For example, approximately 7

I/min can be applied to a lower portion of a two-wheel vehicle to remove dirt from the pedals, chain and rear derailleur.

The area of the housing 3 accommodating the cleaning device 1 comprises along the edge of its open side 5 in the direction of the object blinds or brushes for collecting 12 cleaning medium, for example, in the form of sprayed water. Said brushes can be 15 mm wide, for example. The area of the housing 3 accommodating the cleaning device 1 is configured here in the form of a box.

The height of a respective cleaning roller 11 can be approximately 760 mm. In this way, advantageously, an adaptation to handlebars located at an average height of 800 mm is given. Only handlebars and saddle are not touched by this, in contrast to tires and frame of an average bicycle. The dimensions are also advantageously suited to be placed in a middle class multi-purpose car.

A holding device 9 according to FIG. 1 is additionally provided here as protection against sprayed cleaning medium, for example, in the form of a plastic disc, in particular, as a transparent disc. The cleaning jet protection disc can, for example, be made of polyethylene PET. This disc may cover the open side 5.

The apparatus may operate without a fixed water connection. Water can be taken from a container built into the apparatus. For example, dirty water can be cleaned via three filter stages of 100 μm, 20 μm, and 5 μm.

The control device 4 is set such that the cleaning rollers 11 which can also be referred to as cleaning brushes do not distribute any dirt or water outside the apparatus V during rotation. If there is no bicycle in the apparatus, the cleaning rollers 11 turn “inwards”, that is, the first counter-clockwise and the second clockwise. If a bicycle is inserted, this is detected by the cleaning rollers 11, since pressure is exerted on them and the electric motors have to increase power and “draw” more current. The cleaning rollers 11 then turn clockwise and counter-clockwise for a few seconds. In this way, the cleaning effect is efficiently increased. Water losses are avoided and persons are not soiled. The cleaning medium can be water or any known liquid. Additions are also possible. The control device 4 can comprise a microprocessor which can detect electric motor currents and output corresponding control signals for the directions of rotation and rotation times.

If a pressure on a cleaning roller 11 is too high, it is stopped by means of control device 4 and a restart is attempted after a few seconds. If this was not possible ten times in succession, an error message is output at the control device 4. If this is the case, the entire apparatus must be restarted, for example, by pressing an emergency stop switch. After it has been approved, the apparatus can be put back into operation. In this way, the electric motors can be protected.

FIG. 9 shows a view of a conventional cleaning head. The cleaning head 6 is rotatable around a vertical axis here. It can splash out and/or spray out a cleaning medium, particularly preferred water, may be made of stainless steel, and here comprise three spraying compartments which spray into an area of an upper hemisphere. According to FIG. 8, the cleaning head 6 is arranged between two cleaning rollers 11 so that the hemisphere of the spraying can change in the form of a funnel. Continuous cleaning can be carried out using the cleaning head 6.

FIGS. 10 to 12 show a second embodiment of an apparatus V according to the invention. The apparatus V comprises a housing 3 with an open side 5. In the open side 5, two cleaning rollers 11 are arranged as cleaning device 1 which are rotatably mounted in the vertical direction.

In front of the open side 5, an accommodation area 7 is configured to accommodate the object to be cleaned, in particular a two-wheel vehicle. A guide trough 8 is arranged in the accommodation area 7. The guide trough 8 consists of a multitude of rollers 14. A ramp 15 is provided for entry into the guide trough 8 via which a two-wheel vehicle can be moved into the accommodation area 7.

In addition to the cleaning rollers 11, several cleaning heads 6 are arranged which spray the object to be cleaned with cleaning medium in the accommodation area 7. A cleaning head 6 is arranged such that it sprays the object from below. Two cleaning heads 6 are also arranged on the entry side of the cleaning rollers 11, as well as between the cleaning rollers 11 in the vertical direction.

The accommodation area 7 is limited on the opposite side of the open side 5 by a splash guard 21.

A control device 4 is arranged on the housing 3. The power supply of the apparatus V can be provided by a solar panel 16 located on the cover of the apparatus V.

As only shown in FIG. 11, a prewashing area 17 is arranged next to the accommodation area 7 laterally of the apparatus V.

It is also readily apparent from FIG. 11 that the apparatus V has a modular structure. The apparatus V is composed of the housing 3, the prewashing area 17, the splash guard 21, and the accommodation area 7.

The third embodiment of an apparatus according to the invention shown in FIG. 13 shows a first apparatus V1 and a second apparatus V2 which are arranged opposite each other with their open sides 5 and 5′. The modular structure of the apparatuses V1 and V2 according to the invention allows such an arrangement to be achieved in a simple manner.

The accommodation area 7 is surrounded on two sides by cleaning rollers 11 and 11′ mounted in vertical direction. For a cleaning of the object, therefore, only a single pass through the accommodation area 7 is necessary. In addition to the accommodation area 7, a prewashing area 17 is arranged on the apparatus V2.

For the embodiments of an apparatus V according to the invention described in FIGS. 10 to 14, transport rollers 13 are respectively arranged underneath the apparatus V. This allows the apparatus V to be easily moved and transported.

In FIG. 14 a bearing 18 for the mounting of the cleaning rollers 11 is shown. The bearing 18 is arranged in a recess 22 provided for this purpose in a plate 24.

For the rotation of the cleaning rollers 11, the cleaning rollers 11 are non-rotatably connected to a drum motor 20 by means of grub screws 19. The drum motor 20 is also mounted on the plate 24 by means of a threaded rod 26.

A gap 28 is provided between the bearing 18 and the plate 24 through which cleaning medium can pass from the cleaning rollers 11 without exerting a negative influence on the bearing.

FIG. 15 shows the apparatus V according to the invention with a filter area 30 arranged in the housing 3. The filter area 30 is arranged spaced apart from the accommodation area 7. Cleaning medium used for cleaning the object runs along the arrows R below the cleaning rollers 11 through a grid-shaped structure 31 into the filter area 30. In the filter area 30, a filter mat 32 is arranged. Loose filter material 33 in the form of filter balls is arranged above the filter mat 32 when viewed in the vertical direction. By means of a pump 34, the contaminated cleaning medium is pumped through the filter area 30 and into a filter cartridge 35. A cleaning head 6 is arranged downstream of the filter cartridge 35 to which the cleaning medium passes after passing through the filter area 30 and the filter cartridge 35.

The filter area 30 is preferably arranged below the cleaning rollers 11. The filter area 30 is preferably sealed compared to the rollers 11 so that no unfiltered contaminated cleaning medium can reach the rollers 11. The cleaning medium is drawn, for example, in the accommodation area 7 and through openings (arrows R) into the filter area 30.

The filter area 30 is shown in FIG. 16. The contaminated cleaning medium flows through openings into the filter area 30 at the lower edge and is drawn in by the pump 34 initially through a filter mat 32 with coarse filter material, subsequently through a filter mat 32 with fine filter material and thereafter through loose filter material 33. The loose filter material 33, for example, is composed of filter balls (e.g. Aqualoon®), which are also preferably arranged in a net. This allows the filter balls to be easily removed or replaced from the filter area 30. The flow path can, for example, be defined by Z-partitions 36 so that the cleaning medium to be filtered is diverted through these Z-partitions 36 and fed to the pump 34.

FIG. 17 shows a fifth embodiment of an apparatus V according to the invention. The apparatus comprises a housing 3 which, viewed in the longitudinal direction, has an opening 38 in the form of an accommodation area 7. A cleaning roller 11 is arranged on the left and right of the accommodation area 7 on the housing 3. The filter area 30 extends below the cleaning rollers 11.

A ramp 15 is provided for the introduction of a bicycle which merges into a guide trough 8 with rollers 14. The housing 3 shown in this fifth embodiment has the same dimensions as a housing 3 shown in the previous embodiments. In this case, the object is not moved along the length of housing 3, but through the opening 38 through the accommodation area 7 which extends transversely to the longitudinal direction of the housing 3.

The embodiments of the invention shown here are only examples. Alternatives within the scope of protection are also covered.

1. An apparatus for cleaning an object, in particular a two-wheel vehicle, comprising a housing that accommodates a cleaning device and has an open side on which the object and the housing can be positioned relative to one another and from which the cleaning device can be operated so as to act on the object, wherein the cleaning device is provided with a control device for controlling the cleaning device.

2. The apparatus according to claim 1, wherein the cleaning device comprises two brush-like cleaning rollers which can be rotated by an electric motor.

3. The apparatus according to claim 2, wherein the cleaning device has a rotatable nozzle cleaning head for dispensing cleaning medium in an intermediate area between the two rotatable cleaning rollers on the open side.

4. The apparatus according to claim 1, wherein the area of the housing accommodating the cleaning device along the edge of its open side in the direction towards the object comprises blinds or brushes for collecting cleaning medium.

5. The apparatus according to claim 2, wherein the control device is arranged so as to rotate the cleaning rollers in opposite directions of rotation in a first operating mode, wherein in particular a first of the cleaning rollers rotates counter-clockwise seen from above and a second of the cleaning rollers rotates clockwise seen from above.

6. The apparatus according to claim 5, wherein the control device is arranged so as to rotate the cleaning rollers in a second operating mode alternately for a period in the seconds range in the clockwise direction and counter-clockwise, respectively.

7. The apparatus according to claim 6, wherein the control device is arranged so as to change from the first operating mode to the second operating mode when the object to be cleaned is pressed against the cleaning rollers and in this way, the electromotive power requirement increases.

8. The apparatus according to claim 7, wherein the control device is arranged so as to change from the second operating mode to the first operating mode when the object to be cleaned is removed from the cleaning rollers and in this way, the electromotive power requirement decreases.

9. The apparatus according to claim 5, wherein the control device is arranged so as to switch off the cleaning rollers and/or the apparatus in such a way that they can be switched on again, if a limit value for a pressure against the cleaning rollers is exceeded.

10. The apparatus according to claim 3, wherein a circuit comprising a container and filter is formed within the device, which circulates the cleaning medium, in particular water.

11. The apparatus according to claim 1, wherein a prewashing area is arranged at a distance from the open side.

12. The apparatus according to claim 1, wherein the object to be cleaned is guided in a guide trough through the apparatus, wherein the guide trough is formed by rollers.

13. The apparatus according to claim 1, wherein a solar panel is arranged on the housing.

14. The apparatus according to claim 1, wherein the housing and the cleaning device are detachably connected to one another.

15. The apparatus according to claim 1, wherein a filter area is arranged in the housing, wherein the filter area comprises at least one filter mat, and loose filter material arranged above it, when viewed in the vertical direction, wherein a pump pumps cleaning medium through the at least one filter mat and the loose filter material into at least one filter cartridge.
